(19) United States
(12) Patent Application Publication
(10) Pub. No.: US 2003/0190580 A1
(43) Pub. Date: Oct. 9, 2003

(54) Dispenser and applicator device

(76) Inventor: Christina Khachatourian, Grand Terrace, CA (US)

Correspondence Address: MILORD & ASSOCIATES, P.C., 10880 WILSHIRE BOULEVARD, SUITE 2070, LOS ANGELES, CA, 90024, US

(21) Appl. No.: 10/116,830

(22) Filed: Apr. 5, 2002

(51) Int. Cl. A61C 17/02

(52) U.S. Cl. 433/80; 433/89

(57) ABSTRACT

A single-use disposable device for dispensing and applying a fluid, such as pressure indicator paste, having a frontal region with a dispensing element thereon for dispensing the fluid and a rear region with a manipulating region thereon for applying the fluid.

### FIELD OF THE INVENTION

The invention relates to the dental field in general, and specifically to a single-use, combination paste dispenser and applicator unit having an end prefilled with paste and another end having a brush to spread said paste, more specifically said paste being pressure indicator paste.

### BACKGROUND OF THE INVENTION

Pressure indicator paste and methods to apply various dental pastes are known in the prior art and are widely used. For example, U.S. Pat. No. 4,411,623 to Axelsson discloses a single-use means of applying toothpaste to the interspaces of teeth using a plastic tube with a terminal, laterally tapered nozzle small enough to fit between teeth and deliver toothpaste. Axelsson's device does not have a brush for spreading paste, and while it is single-use it specifically indicates use with toothpaste for delivery between teeth and does not contemplate use with pressure indicating paste.

U.S. Pat. No. 4,512,741 to Mushta discloses a dental indicating paste comprised of oils which is blended with indicating powder to form a soft, creamy paste and is then mixed with a liquid hydrocarbon that acts as a solvent and a propellant for the indicating paste and allows the paste to be dispensed from an aerosol spray can. Mushta's device is neither single-use nor does it have a brush for spreading said paste.

U.S. Pat. No. 4,871,261 to Randklev discloses a subatmospheric mixing apparatus which is comprised of a capsule having a structure defining an internal compartment adapted to contain a quantity of ingredients, a holding mechanism for releasably supporting the capsule, and means for oscillating the holding mechanism in order to mix the ingredients within the same.

U.S. Pat. No. 5,048,731 to Moreschini discloses a paste dispensing cup with a ring for attaching to the user's finger while applying the paste, however, the paste contemplated in Moreschini's device is polishing paste specifically of the type used for tooth cleaning in conjunction with an electronic tooth polishing device. The invention itself relates to the container device holding a pre-measured amount of tooth polishing paste and does not have a brush for application of the paste. Additionally, Moreschini's device itself is specifically designed for use in conjunction with a tooth polisher and not for use with pressure indicator pastes for denture fittings.

U.S. Pat. No. 5,554,665 to Tateosian, et. al._discloses a method of forming dental products from two polymerizable paste compositions each having a complimentary component of a free radical catalyst system and a polymerizable acrylic compound. The paste compounds are had within two containers and dispensed therefrom.

The aerosol spray method of paste application is a more expensive and complex of paste application than the method disclosed in the instant invention, and other methods of paste application require separate cups and brushes and spatulas for use in conjunction with bulk quantities of the pressure indicator paste. None of the prior art references disclose all of the features of the instant invention either alone or in combination. Therefore, there remains a continuing need for an advance in the art beyond the existing pressure indicating paste delivery methods and paste application methods that is space efficient, time efficient, manipulable, single-use, waste reducing, economical, hygienic, and unitary.

### SUMMARY OF THE INVENTION

Accordingly, it is a general object of the present invention to overcome the disadvantages of the prior art.

Therefore, it is a primary objective of the invention to provide a means of dispensing and applying pressure indicator paste that overcomes the disadvantages of the prior art.

It is another objective of the invention to provide a cost-efficient means to dispense and apply pressure indicator paste.

It is another objective of the invention to provide a time saving means to dispense and apply pressure indicator paste by removing the need for separate cups and applicator tools.

It is yet another objective of the invention to provide a means of decreasing paste wasted during the dispensation of pressure indicator paste by providing a predetermined amount of paste in the dispensing portion of the unit.

It is a further objective of the invention to provide a means of dispensing and applying pressure indicator paste that is convenient for the user.

It is another objective of the invention to provide a more hygienic means of using pressure indicator paste in the dental setting by creating a sealed, single-use unit and thereby eliminating the need to extract an amount of paste from a bulk container.

It is another objective of the invention to provide the patient with a choice of paste flavors, such as mint or fruit flavors available from paste manufacturers.

It is a further objective of the invention to eliminate the need for bulk containers of pressure indicator paste, thereby saving storage space.

It is another objective of this invention to provide a paste dispensing and applying means which is disposable after a single use.

In keeping with the principles of the present invention, a unique paste dispensing and application device is disclosed that is a single-use, unitary paste dispensing and paste applying device for use in the dental field. Specifically, the device is used to achieve proper fitting of dentures to prevent soreness or irritation of the tissues in the patient's mouth and in the case of dental castings to ensure proper seating.

The unit, in one preferred embodiment, is comprised of an elongated, generally cylindrical body having one hollow portion of the cylinder filled with an amount of pressure indicator paste. The other distal portion, comprised of solid material in one preferred embodiment, forms a handle with a brush generally located terminally on said handle portion. The length and diameter of the paste-filled portion are of any sufficient size to contain enough paste for a single application, and to allow for ease in handling and use. The paste-filled portion terminates in a removable tip which, when removed, creates an opening through which the paste may be dispensed from the cylinder onto the desired surface. The paste may then be applied to a desired surface using the brush.

Such stated objects and advantages of the invention are only examples and should not be construed as limiting the present invention. These and other objects, features, aspects, and advantages of the invention herein will become more apparent from the following detailed description of the embodiments of the invention when taken in conjunction with the accompanying drawings and the claims that follow.

### BRIEF DESCRIPTION OF THE DRAWINGS

FIG. 1 is a perspective view of one preferred embodiment of a paste dispenser and applicator device.

FIG. 2 is a longitudinal cross sectional view of one preferred embodiment of the paste dispenser and applicator device taken along line 2-2 of FIG. 1.

FIG. 3 is a perspective view of an alternate preferred embodiment of the paste dispense and applicator device.

### DETAILED DESCRIPTION OF THE INVENTION

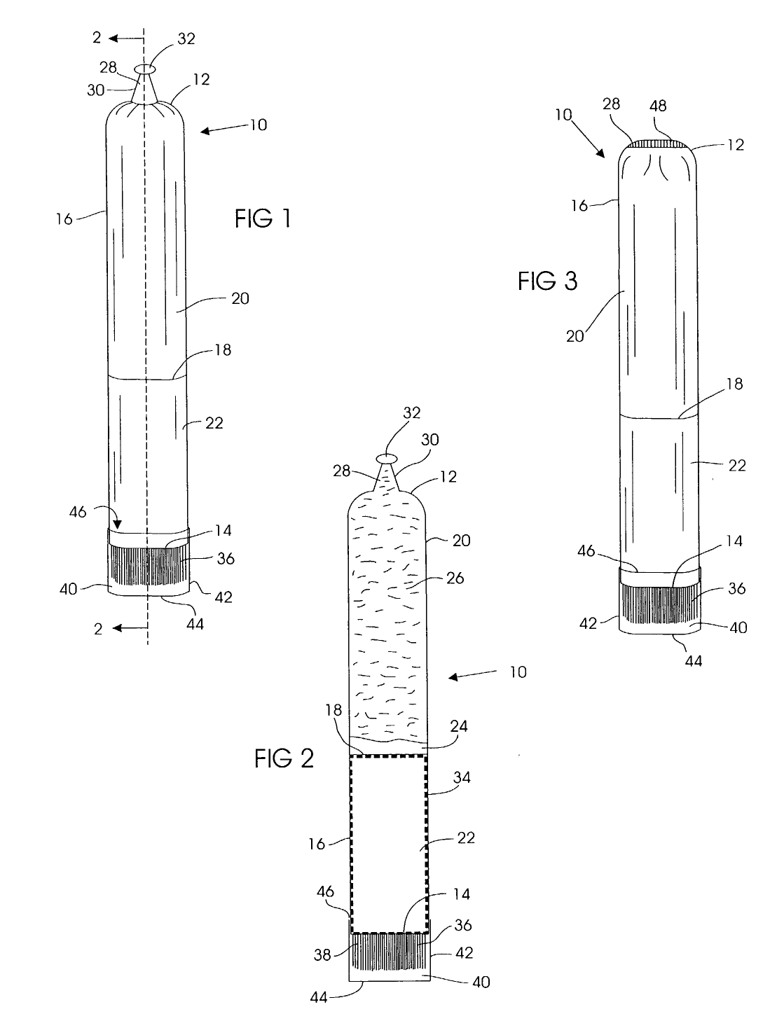

Referring now to FIGS. 1 and 2, a device 10 is illustrated for dispensing, applying, and manipulating fluids in general, and, more specifically, pressure indicating paste. Device 10 may be individually packaged in a hermetically sealed wrapper (not shown) of a type found on other medical supplies to preserve the sterilized environment therein. Device 10 has a first end 12 and a second end 14 distal to the first end 12 such that an elongated structure is achieved. Although a tubular shape is herein illustrated in one preferred embodiment, it is to be understood that device 10 may be made of any other suitable shape such as, but not limited to, a rectangle. An outer wall 16 defines the structure of device 10 and has a median 18 that separates device 10 into a frontal region 20 and a rear region 22. Frontal region 20 has a cavity 24 therein defined by outer wall 16, median 18, and first end 12. Cavity 24 is filled with a fluid 26 and in a preferred embodiment, fluid 26 is pressure indicating paste.

First end 12 of device 10 has a dispensing element 28 defined thereon. Dispensing element 28 is made of a tapered wall 30 such that the diameter of wall 30 decreases as wall 30 extends outwardly from first end 12. A stopper 32 is placed at an apex of wall 30 and may be removed by twisting or cutting such that fluid 26 may be dispensed from cavity 24 and through tapered wall 30 via an opening created by the removal of stopper 32. Outer wall 16 is made of a polymeric material, such as plastic, which is sufficiently flexible to allow the fingers of a user to squeeze the same in order to dispense fluid 26 contained therein. Outer wall 16 may also be made of a transparent plastic such that the contents therein may be observed. The amount of fluid 26 contained within frontal region 20 is of a predetermined amount to allow one-time application of fluid 26 and use of the device 10.

Rear region 22 is comprised of outer wall 16, median 18, and second end 14. Outer wall 16 has a strengthening means 34 therein to provide a sturdy rear region 22 that allows handling thereof without twisting or bending. Rear region 22 may be of sufficient length and diameter to allow ease in use and handling by a user's hand. Strengthening means 34, for purposes of illustration not limitation, may be formed by thickening outer wall 16 along the length of rear region 22.

A manipulating means 36 is located on second end 14 and is adapted to manipulate the pressure indicating paste or other fluid while in the mouth of a patient to conform to a desired location or shape. Manipulating means 36 in one preferred embodiment may be formed of a plurality of bristles 38 to from a brush like head. Bristles 38 may be of any size, shape, and texture suitable for or typically used in conjunction with the applying paste. However, it is also to be understood that manipulating means 36 may also be shaped in the form of dentals tools that are known for treating the teeth of a patient.

A cap 40 that is generally cup shaped having a circumference 42 extending from a bottom 44 whereby an opening 46 is defined distal to bottom 44. Opening 46 defined by circumference 42 is of a diameter and a shape compatible with the diameter and shape of outer wall 16 and is removably received thereon to cover manipulating means 36. Cap 40 may be comprised of any suitable material such as plastic. Cap 40 may also be of compatible diameter and shape to removably attach to and cover first end 12 and dispensing element 28 after cap 40 has been removed.

Now referring to FIG. 3, an alternate preferred embodiment of device 10 is illustrated. At first end 12, outer wall 16 may be pressed flat to form a sealed region 48 that may be removed by any suitable means such as cutting or tearing along a predetermined length thereof to form an opening for the expulsion of fluid 26 contained within frontal region 20.

While the above description contains many specifics, these should not be construed as limitations on the scope of the invention, but rather as an exemplification of preferred embodiments thereof. Many other variations are possible without departing from the essential spirit of this invention. Accordingly, the scope of the invention should be determined not by the embodiment illustrated above, but rather by the appended claims and their legal equivalents.

What is claimed is:

1. A dispenser and applicator device, comprising;
a first end and a distally located second end that are interconnected by an outer wall;
a cavity for storing a fluid therein defined within said outer wall;
a dispensing element located on said first end for controlled expulsion of said fluid;
a manipulating means located on said second end.

2. The device of claim 1, wherein a median extends perpendicularly from said outer wall inwardly such that a frontal region is defined between said median and said first end and a rear region is defined between said median and said second end.

3. The device of claim 2, wherein said cavity is defined by said median, said outer wall of said frontal region, and said first end.

4. The device of claim 2, wherein a reinforcing means is included within said rear region.

5. The device of claim 4, wherein said reinforcing means comprises thickening of said outer wall along said rear region.

6. The device of claim 1, wherein said dispensing element is further comprised of a tapered circumferential wall that extends from said first end and a diameter of said circumferential wall decreases as a height of said circumferential wall increases.

7. The device of claim 1, wherein said dispensing element is conically shaped.

8. The device of claim 1, wherein said fluid is dental pressure indicator paste.

9. The device of claim 1, wherein said manipulating means is comprised of a plurality of bristles that extend from said second end to form a brush.

10. The device of claim 1, wherein a removable cap is positioned over and encloses said manipulating means when said manipulating means is not in use, and said cap also removable engages said first end and encloses said dispensing element when said manipulating means is in use.

11. The device of claim 2, wherein said frontal region is made of a flexible material.

12. A dispenser and applicator device for use in a dental field, comprising:
a first end and a distally located second end that are interconnected by an outer wall;
a median extending inwardly from said outer wall and defining a frontal region between said median and said first end and also defining a rear region between said median and said second end;
a cavity for storing a fluid therein defined by said outer wall, said median, and said first end;
a dispensing means located on said first end for controlled expulsion of said fluid; and
a manipulating means located on said second end.

13. The device of claim 12, wherein said frontal region is substantially flexibly such that said fluid may be squeezed out of said dispensing means by a hand of a user.

14. The device of claim 12, wherein said device is made of a polymeric compound.

15. The device of claim 12, wherein said dispensing element further comprises a tapered circumferential wall that extends from said first end; and a diameter of said circumferential wall decreases as a height of said circumferential wall increases such that a tip is formed having a stopper thereon.

16. The device of claim 15, wherein an aperture is formed upon removal of said stopper through which said fluid may be dispensed in a controlled manner.

17. The device of claim 12, wherein said rear region has a strengthening means to prevent said device from bending or twisting while the manipulating means is being used.

18. The device of claim 12, wherein a removable cap is positioned over and encloses said manipulating means when said manipulating means is not in use, and said cap also removable engages said first end and encloses said dispensing element when said manipulating means is in use.

19. The device of claim 18, wherein said cap further comprises a circumference extending from a bottom in order to form an opening at a point of said circumference distal to said bottom, whereby said outer wall of said device is received within said opening and is frictionally engaged by said circumference.

20. A single-use and disposable pressure indicating paste dispenser and applicator device, comprising:
a first end and a distally located second end that are interconnected by an outer wall;
a median extending inwardly from said outer wall and defining a frontal region between said median and said first end and also defining a rear region between said median and said second end;
a cavity for storing said pressure indicating paste therein defined by said outer wall, said median, and said first end;
a dispensing means located on said first end for controlled expulsion of said fluid; and
a manipulating means located on said second end, said manipulating means being defined by a plurality of bristles extending from said second end.
